(19) United States
(12) Patent Application Publication
(10) Pub. No.: US 2022/0027899 A1
(43) Pub. Date: Jan. 27, 2022

(54) METHOD AND DEVICE FOR CONTROLLING A CRYPTOCURRENCY

(71) Applicant: Robert Bosch GmbH, Stuttgart (DE)

(72) Inventors: Alexander Poddey, Wiernsheim (DE); Nik Scharmann, Bietigheim-Bissingen (DE)

(21) Appl. No.: 17/325,808

(22) Filed: May 20, 2021

(30) Foreign Application Priority Data
Jul. 21, 2020 (DE) 102020209138.2

(51) Int. Cl. G06Q 20/38; G06Q 20/06

(52) U.S. Cl. CPC G06Q 20/389; G06Q 20/065

(57) ABSTRACT

A method for controlling a cryptocurrency. An asked price of the cryptocurrency is adapted to a circulation amount of the cryptocurrency according to the bonding curve. While the circulation amount is increasing, a currency reserve of the cryptocurrency is deposited. The bonding curve is changed as soon as the currency reserve reaches a certain minimum amount in such a way that the asked price is supported with the aid of the currency reserve.

### CROSS REFERENCE

The present application claims the benefit under 35 U.S.C. § 119 of German Patent Application No. DE 102020209138.2 filed on Jul. 21, 2020, which is expressly incorporated herein by reference in its entirety.

### FIELD

The present invention relates to a method for controlling a cryptocurrency. The present invention moreover relates to a corresponding device, a corresponding computer program as well as a corresponding memory medium.

### BACKGROUND INFORMATION

Any protocol in computer networks that brings about a consensus with regard to the sequence of certain transactions is referred to as a decentralized transaction system, a transaction database or a distributed ledger. A frequent implementation of such a system is based on a blockchain and forms the basis of numerous so-called cryptocurrencies.

Advanced cryptocurrencies make use of a mechanism that is known as curved bonding and according to which a function is algorithmically defined that is referred to as a bonding curve and that has an influence on the price of the tokens of the currency as a function of their liquid assets.

A computer-implemented method for managing a cryptocurrency with the aid of curved bonding is described in PCT Patent Application No. WO 2019/043668 A1. For this purpose, a plurality of users is provided with a market-internal wallet that is suitable for storing linked digital tokens that are linked in terms of their values to the cryptocurrency tokens and must be traded on a digital marketplace platform. A cryptocurrency reserve is provided for storing the cryptocurrency tokens. If a user buys linked digital tokens in a marketplace transaction, the linked digital tokens are transferred to the wallet of the marketplace and the appropriate value is transferred to the cryptocurrency reserve in the form of cryptocurrency tokens. As a response to the fact that a user retrieves a number of linked digital tokens from the market-internal wallet, the desired number of linked digital tokens is removed from the market-internal wallet of the user and an equivalent value is transferred in the form of cryptocurrency tokens from the cryptocurrency reserve to a market-external wallet of the user for storing the cryptocurrency tokens outside of the marketplace platform.

U.S. Patent Application Publication No. US 2020/0167512 A1 describes a scale for the simulation of the operation of a blockchain system. The simulation may result in quantitative, practical estimations of how the variation of the bonding curve or other aspects of the system design affect the performance, costs, and other metrics of interest. This is intended to make it possible for designers and users to use data generated in one test or model in a different test and to optimize the parameters or the protocol of the system with regard to one or several target functions.

A generalization of bonding curves that is intended to simplify the examination of the effects of adapting the course of the function based on so-called configuration spaces is provided in ZARGHAM, Michael; SHORISH, Jamsheed; PARUCH, Krzysztof, “From Curved Bonding to Configuration Spaces,” 2019.

One alternative to curved bonding for mitigating the volatility and for stabilizing cryptocurrencies is discussed in SHIBANO, Kyohei; LIN, Ruxin; MOGI, Gento, “Volatility Reducing Effect by Introducing a Price Stabilization Agent on Cryptocurrencies Trading,” In: Proceedings of the 2020 The 2nd International Conference on Blockchain Technology,” 2020, pp. 85-89.

### SUMMARY

The present invention provides a method for controlling a cryptocurrency, a corresponding device, a corresponding computer program as well as a corresponding machine-readable memory medium s.

An example embodiment of the present invention is based on the finding that cryptocurrencies generally use so-called security tokens that make it possible for investors and users to get involved in the particular system and its further growth. This appreciation should be divided between the developers, early investors, and users according to their contribution.

Based on the stock market, such a distribution of tokens typically follows the following order: A certain number of tokens is reserved for the developers and initial investors; one or multiple presale(s) is/are executed; the tokens are subsequently offered in free trading via crypto exchanges. The market value at the exchanges then results from the demand.

In the case of crypto tokens, in particular, the demand and thus the rate often do not correlate, however, with the actual value of the system and is subject to great fluctuations due to speculation or even systematic rate manipulation. This makes it possible for malicious market participants to drive the price up with the aid of misleading media coverage and to buy larger tranches of tokens, in order to initiate the price increase spiral related to the investors' fear of missing out (FOMO), which then makes it possible for them to exit the market by selling the tokens at the highest rate possible. If the founders and early investors are involved, this action is referred to as an exit scam.

An active dumping of the price is furthermore taken into consideration, to induce other market participants to panic selling and eventually buy tokens below value; this action is often applied in alternation with buying tokens (pumping). In some cases, criminal exchanges even misuse their unpublished knowledge about incoming orders, establish buying and selling limits, etc., and thus initiate a pump-and-dump dynamic in the sense stated above.

Eventually, using one's knowledge about the fact that other parties will buy a token makes it possible to buy it for oneself immediately prior, via so-called frontrunning, and to then sell the token at a higher price.

Bonding curves essentially account for these risks in that they guarantee a selling price depending on the circulation amount of the cryptocurrency. This is possible in that a corresponding token volume is locked as a reserve depending on the implementation. Since a generic bonding curve converges toward zero with a limiting value of 0, the price decreases as more and more market participants sell off their tokens to the market maker. The risks outlined above are thus mitigated, but not eliminated.

It is thus provided according to an example embodiment of the present invention that the circulation amount and other key data are used for reference, in order to measure the value, the usability, and the use of the system, to collect some type of tax, and to use the generated income together with the revenues of the market maker for the purpose of increasing the reserve. The bonding curve is changed continuously or as soon as this currency reserve reaches a certain minimum amount in such a way that the guaranteed asked price—corresponding to the growing financial power of the currency system—is supported with the aid of the reserve and the created value is redistributed among all market participants.

One advantage of this “reinforcing” of the market selling price is based on improved coupling of the profit of the developers, early investors, and users to the value generated by the currency system.

The measures disclosed herein make advantageous refinements of and improvements on the basic features of the present invention disclosed herein possible.

### BRIEF DESCRIPTION OF THE DRAWINGS

Exemplary embodiments of the present invention are illustrated in the figures and explained in greater detail in the description below.

FIG. 1 shows the flowchart of a method according to a first specific embodiment of the present invention.

FIG. 2 shows a first bonding curve.

FIG. 3 shows a second bonding curve.

FIG. 4 shows a third bonding curve.

FIG. 5 shows a fourth bonding curve.

FIG. 6 shows a fifth bonding curve.

FIG. 7 schematically shows a server according to a second specific embodiment of the present invention.

### DETAILED DESCRIPTION OF EXAMPLE EMBODIMENTS

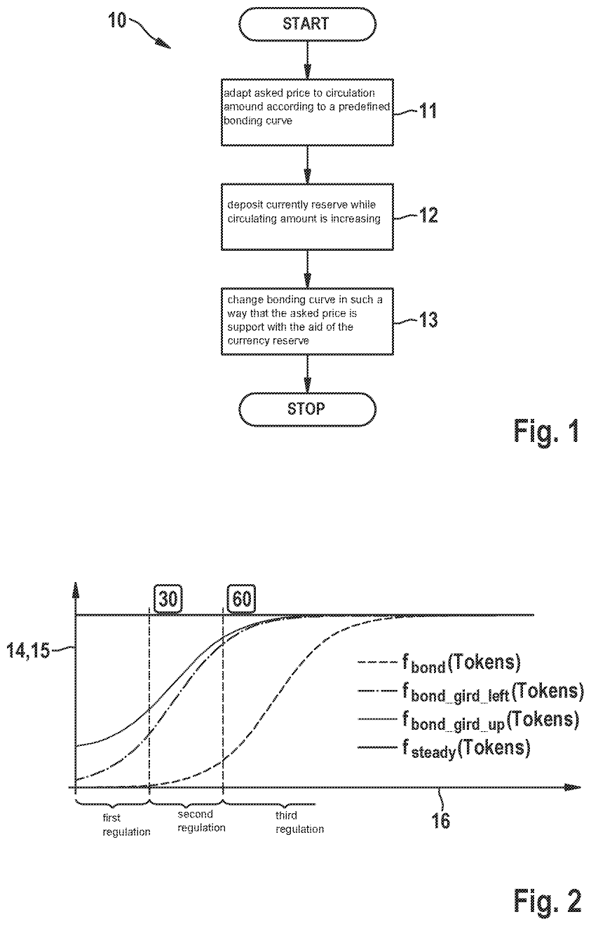

FIG. 1 illustrates the basic steps of a method 10 according to an example embodiment of the present invention based on a fictive cryptocurrency, whose asked price is initially adapted to its circulation amount in an conventional manner according to a predefined bonding curve (process 11). While the circulation amount is increasing, a currency reserve of the cryptocurrency is deposited according to the present invention (process 12). Ideally, the bonding curve is changed continuously or at least as soon as it reaches a certain minimum amount (process 13) in such a way that the asked price is supported with the aid of the currency reserve. In a mature, stable ecosystem, the bonding curve either converges toward infinity—as is illustrated in FIG. 2—having a finite limiting value or it rises in an open-ended upward trajectory.

Examples of metrics and taxes related thereto include the incomes generated by the bid-ask-spread and the circulation speed of the tokens as well as transaction costs and transaction volume: DLT systems generally apply a transaction fee together with their own price model. The transaction volume and the fees represent an indicator for the instantaneous intrinsic value of the system. Some of these fees may be used to increase the reserve and adapt the trajectory of the bonding curve.

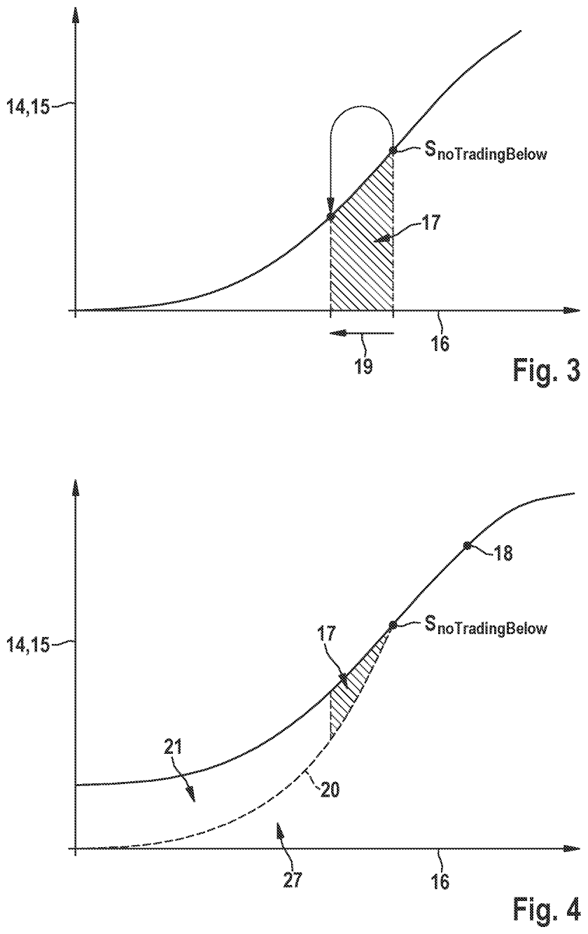

According to FIG. 3, the primary trading using this cryptocurrency is initially stopped 19 and the tokens issued in this rollout phase are locked in a conventional manner until circulation amount 16 has exceeded a certain minimum (S_{noTradingBelow}) and currency reserve 17 has thus reached its intended scale. Reserve 17 increased in this manner is used to fill, so to speak, the area below this curve section and correspondingly shifts S_{noTradingBelow} along the abscissa axis to the left, thus unlocking the corresponding portion of the tokens. This “left shift” generates an area between the two curves that determines the minimum scale of reserve 17 required for the shift.

The approach shown in FIG. 4 provides to start with an initial trajectory 20 of the bonding curve, which is predefined by deposited currency reserve 27 and is considerably below target price 21 that depends on circulation amount 16 and is intended to offer all market participants the possibility of a fair market exit in the long term. The circulation amount (S_{noTradingBelow}) required for the primary trading is determined in this case by that point of the curve, at which initial 20 and final 21 trajectory of the bonding curve merge. Reserve 17 increased in this manner is also used here to fill, so to speak, area 27 below this curve section and correspondingly shifts S_{noTradingBelow} to the left.

In one modification, a trading that in principle includes all tokens could already be allowed in the area of the dashed line in FIG. 4; currency reserve 27 deposited for this purpose would correspond to the area below this curve in this case. In such a specific embodiment, currency reserve 17 would “fill,” so to speak, the difference over time until the desired curve shape is reached, trading would in general be admissible, however, even before circulation amount S_{noTradingBelow is} reached. The above-named approaches prevent exit scams by locking the tokens and by unlocking them based on the value increase in the currency system.

The change in the bonding curve for the bid or asked price is furthermore taken into consideration in the area between the origin and instantaneous circulation amount 18 with the aid of increased currency reserve 17. For this purpose, the price is generally revised upward in the case of a certain circulation amount 16, by which the price is increased and every investor is granted advantages. In this way, not only is the guaranteed asked price supported in the case of a market exit, but also the price in the usually examined range that is achievable during trading is increased, thus generating profit for all market participants.

An adaptation of the trajectory of the bonding curve in the area above instantaneous circulation amount (18) is furthermore to be contemplated, for example by shifting or curving upward in the sense of a price increase.

One feature of the curved bonding is that the profit for token holders, in particular for developers, early users, etc., who buy tokens at low prices, is delimited by the bonding curve, thus delimiting inappropriate profits. However, if the system gains additional user value and wealth, an increased revenue is justified for long-term token holders. The depicted “upward shift” of the curves on the basis of fundamental key data makes it possible to take this specific principle into consideration.

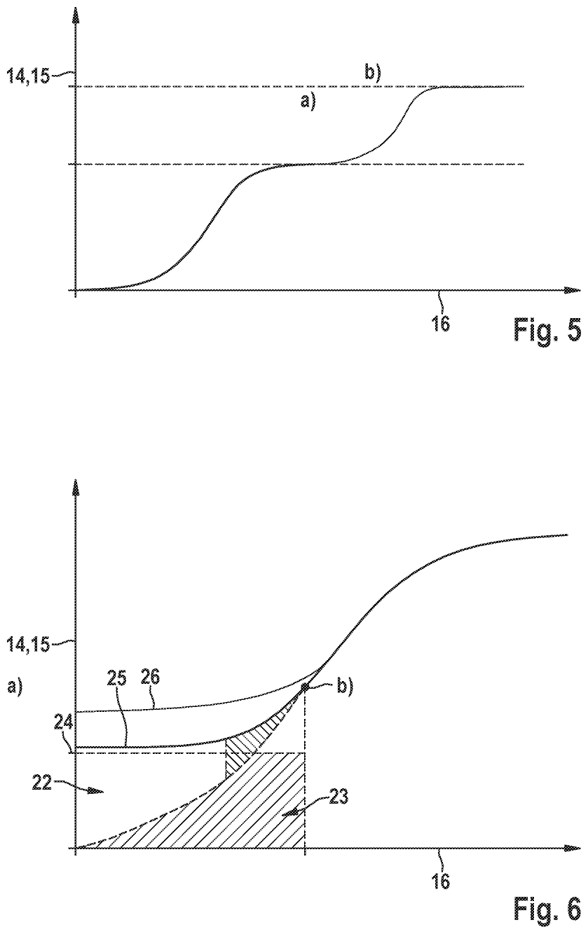

According to a further specific embodiment illustrated in FIG. 5, the initial trajectory corresponds to a sigmoid function having a first limiting value (a). At a certain point in time or whenever the contemplated key data indicate a new developmental phase, this sigmoid function is additively superimposed by a second sigmoid function that is shifted to the right along the abscissa axis in the present example, so that the raised trajectory ultimately corresponds to a function that is convergent toward infinity having a second limiting value (b).

A change in the form of bid prices (15) and asked prices 14 over the entire contemplated range of circulation amount 16 is ultimately taken into consideration, for example by shifting the bonding curve in the sense of a price increase consistently or as a function of circulation amount 16. This process makes it possible to ponder the advantages of an appropriate protection against exit scams and of the general use for all token holders in a targeted manner.

FIG. 6 illustrates the possible link of the above-described approaches starting from a sigmoid bonding curve. Early investors are offered the possibility of buying the cryptocurrency at a cost-effective bid price 15. The area below line 24 corresponds to invested assets 22. A portion of this fixed capital is in turn required as initial reserve 23. The public trading then starts at a point indicated by b.

The difference between initial reserve 23 and invested asset value 22 may be used for the development. For this purpose, b is initially established in a conventional manner up to a point in time, which is referred to in the following as t_{finallyUnlocked}, according to the required minimum amount of the currency reserve. In this way, early investors cannot sell their tokens up to this point in time—which thwarts an exit scam—but they have an ensured possibility of exiting the market in the future, for example if the wealth of the system does not grow to the expected extent.

In the present specific embodiment, a second trajectory of the lower part of the bonding curve is moreover predefined 25 and the approach described above for FIG. 4 is applied. The growing wealth of the system now increases the currency reserve and thus unlocks—even prior to point in time t_{finallyUnlocked}—the portion of circulation amount 16, which is now supported at a higher price. Above-mentioned curve trajectory 25 could be derived from the originally invested sum 22. In this way, it would be ensured in a first phase of the wealth growth that the investors may trade their inventory even prior to point in time t_{finallyUnlocked}, if they so wish, an exit scam being nevertheless effectively prevented. In addition, a further trajectory 26 is defined that predefines the target trajectory of the bonding curve after second trajectory 25 has been fully supported, before the entire or a large part of the bonding curve is ultimately shifted.

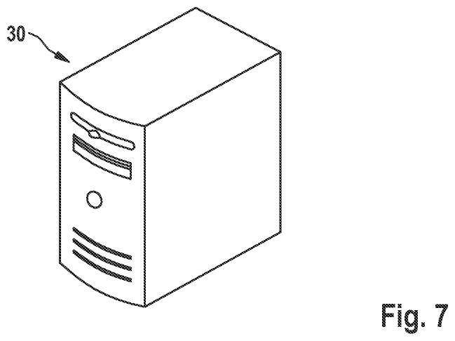

This method 10 may, for example, be implemented in software or hardware or in a mix of software and hardware, for example in a server 30, as the schematic representation of FIG. 7 illustrates.

What is claimed is:

1. A method for controlling a cryptocurrency using a bonding curve, the method comprising the following steps:
adapting an asked price of the cryptocurrency to a circulation amount of the cryptocurrency according to the bonding curve;
while the circulation amount is increasing, depositing a currency reserve of the cryptocurrency; and
changing the bonding curve as soon as the currency reserve reaches a certain minimum amount in such a way that the asked price is supported using the currency reserve.

2. The method as recited in claim 1, wherein the reaching of the certain minimum amount is established when an instantaneous amount of the circulation amount exceeds a certain minimum, and a primary trading using the cryptocurrency is initially stopped until the circulation amount has exceeded the certain minimum.

3. The method as recited in claim 1, wherein an initial trajectory of the bonding curve is predefined by the deposited currency reserve, and the change in the bonding curve takes place in that the trajectory rises to a target price that depends on the circulation amount.

4. The method as recited in claim 3, wherein the initial trajectory corresponds to a function converging to infinity having a first limiting value, and the raised trajectory corresponds to a function converging to infinity having a second limiting value.

5. The method as recited in claim 4, wherein the function converging to infinity having the first limiting value and the function converging to infinity having the second limiting value are sigmoid.

6. The method as recited in claim 5, wherein the sigmoid is logistic.

7. The method as recited in claim 1, wherein a bid price of the cryptocurrency is also adapted to the circulation amount.

8. The method as recited in claim 1, wherein the adaptation takes place as a function of one of the following key data:
transaction costs, or
transaction volume, or
bid-ask-spread, or
circulation speed of currency units of the cryptocurrency.

9. A non-transitory machine-readable memory medium on which is stored a computer program for controlling a cryptocurrency using a bonding curve, the computer program, when executed by a computer, causing the computer to perform the following steps:
adapting an asked price of the cryptocurrency to a circulation amount of the cryptocurrency according to the bonding curve;
while the circulation amount is increasing, depositing a currency reserve of the cryptocurrency; and
changing the bonding curve as soon as the currency reserve reaches a certain minimum amount in such a way that the asked price is supported using the currency reserve.

10. A device configured to control a cryptocurrency using a bonding curve, the device configured to:
adapt an asked price of the cryptocurrency to a circulation amount of the cryptocurrency according to the bonding curve;
while the circulation amount is increasing, deposit a currency reserve of the cryptocurrency; and
change the bonding curve as soon as the currency reserve reaches a certain minimum amount in such a way that the asked price is supported using the currency reserve.
